(19) United States
(12) Patent Application Publication
(10) Pub. No.: US 2013/0290148 A1
(43) Pub. Date: Oct. 31, 2013

(54) SYSTEM AND METHOD FOR ENABLING IMMEDIATE ACCESS TO SECONDARY CONTENT

(71) Applicant: Dana Evan, New York, NY (US)

(72) Inventor: Dana Evan, New York, NY (US)

(21) Appl. No.: 13/459,653

(22) Filed: Apr. 30, 2012

(51) Int. Cl. G06Q 30/06; G06K 15/02

(52) U.S. Cl. 705/27.1; 358/1.18

(57) ABSTRACT

A method for enabling immediate access to secondary content is provided and includes the steps of obtaining an original trigger image, creating a print of the original trigger image, creating digital secondary media content using technology. The method also includes creating at least one mobile application for use in connection with a mobile electronic device. The mobile device including a display and the ability to run a mobile application and/or to send and receive a signal to and from a remote server. The mobile application includes the ability to detect and recognize various objects and is designed so that when it detects the original trigger image it causes the electronic device to display the secondary content. Finally, the disclosed method also includes the step of combining the mobile application with the print of the original trigger image for treatment as a single unit.

### FIELD AND BACKGROUND

The present method relates generally to the field of mobile communications and in particular to new method for allowing a user to access secondary content.

The prior art contains devices and methods for accessing information and displaying information. Further, the prior art contains several systems that facilitate recognition of objects. Furthermore, the prior art contains technology for enhancing digital images.

### SUMMARY

Accordingly, a method for enabling immediate access to secondary content is disclosed. The disclosed method includes the steps of obtaining an original trigger image, creating a print of the original trigger image. The disclosed method also includes the further step of creating digital secondary content using technology. The secondary content could be any type of digital media.

The instant method further includes the step of creating at least one mobile application for use in connection with a mobile electronic device. The mobile electronic device includes a display. The mobile electronic device also includes the ability to run a computer application and/or the ability to send and receive a signal to and from a remotely located backend server.

The mobile application includes the ability to detect and recognize various objects and is designed so that when it detects the original trigger image the electronic device displays the secondary content. Finally, the disclosed method also includes the step of combining the mobile application with the print of the original trigger image for treatment as a single unit.

### DETAILED DESCRIPTION

The particular configurations and embodiments discussed in the following non-limiting examples can be varied and are cited merely to illustrate at least one embodiment and are not intended to limit the scope thereof.

The disclosed system and method can be put to a wide range of uses and can be applied in numerous situations to provide digital information to those who need or desire it. Furthermore, it can be used to gain mobile access to such information.

The basic steps of the disclosed method, all of which will be discussed in greater detail below, are as follows. The first step is selecting and obtaining an original trigger image. Depending upon what is the nature and form of what is chosen as the original trigger image, and what content one desires to associate it with, you then create a print or printout of the original trigger image. Next, you then create digital secondary content to associate with the original trigger image.

As will also be discussed in greater detail below, this can be either an individual or collaborative effort and can be executed by a combination of different people or entities. Next, you create at least one mobile application (hereinafter “App”) for use in connection with a mobile electronic device. The App is specifically designed to be mated with the print. That is to say that it is to detect the trigger image represented by the print and then cause the electronic device to display the secondary content. Then by taking the App and coupling it with the print so that the two are used together and treated as a single hybrid item, you effectively have a system and method which allows access to the secondary content associated with the print.

For example, imagine walking through your house with friends and having artwork on the wall, you take out your tablet computer or smartphone, open a unique mobile App and point the device at the image. Then, a whole new dimension of the work is displayed on your mobile device triggered by the image. It expands the artwork and enriches it, creating a new experience. Thus, among other things, the disclosed system and method allows someone to view an enhanced version of a piece of art. Although the piece of art may be well known, the enhanced version is different. Thus, by combining the application with the print, a user can carry the print and use it to trigger the enhanced version and experience it at any place and at any time they wish.

The original trigger image can be virtually anything from a landscape (e.g., a raw image as seen by the naked eye) to a work of art such as a painting, a sculpture or a piece of furniture. To obtain the original image one can use any electronic device which is capable of capturing an image. For example, you can take a picture using an integral camera on a tablet computer or smartphone. Additionally, you can use a regular digital camera to take a picture and obtain an original trigger image. On the other hand, the original trigger image can be a file which was sent to you as an email attachment or it can be an image, for example a PDF or JPEG file downloaded off the internet.

Next, a print of the original trigger image is created. This can be done by any known or later discovered means. For example the print can be created by a standard printer connected to a home computer. The print is a physical object to be discovered by the App and it includes one or both of embedded code and a visual sign. For purposes of this application, the term embedded code includes within its scope a technical device to be discovered by the App. Furthermore, for purposes of this application, a print shall include within its scope any physical object that is capable of being recognized by its physical appearance and/or can be fitted with an embedded code. A visual sign can be the actual physical appearance of an object itself or can be any kind of identifying mark; for example a unique decal or a virtual fingerprint.

A print can be of any size and it also may have a front side and a back side. The back side can be provided with a mechanism for attaching the print to a surface. For example, it could have some form of adhesive. Alternatively, it could be configured with a magnetic back side which would allow someone to attach the print to a metal surface.

Additionally, the print can be configured as a billboard or a large sign. In such a case, a company or organization, for example, could couple the print with several Apps which it could require it's employees or members to put on their smartphone. Thus, the disclosed system and method could be used by such entities to make sure that their employees or members get information as they walked into work. The App on their mobile devices would detect and recognize the print which would then ultimately result in the display of the secondary content, hence informing them of the relevant information.

The secondary content, which can also be interchangeably referred to as an aura, is a compilation of media and can be made up of one or more portions. It can be any kind of electronic or digital media which includes but is not limited to video based media, photograph or picture based media, audio based media, an animation and augmented reality. Irrespective of what form it takes, secondary content is to be streamed/downloaded to the App as a result of authorized and authenticated object recognition.

In addition, secondary content can take the form of a dedicated application. In which case, special software is executed on the mobile device which allows the mobile user to interact with a server. For example, the Mobile App will display the print and allow the user to change the background color or manipulate the content. Moreover, in general, secondary content can include any now known or later discovered form of information capable of being displayed on a mobile electronic device. Similarly, the actual technology used to create the secondary content can be any now known or later developed means which is capable of obtaining the proper result.

Furthermore, secondary content is electronic content and therefore it will be created and consumed by electronic devices and Apps. In some cases, the secondary content (or aura) itself can be partially or completely consumed during the process of creating the App. That is part or all of the secondary content is actually transformed into an App and becomes all or part of the App. For example, when the secondary content is an enhanced version of an electronic file of a piece of art work, then part or all fo the secondary content (electronic file of the original image) is embedded with codes to facilitate the desired enhancement. is transformed into the mobile application. That is, it is used to create and is literally transformed into the secondary content.

Also, secondary content will often be a work of authorship in its own right, separate from that of the trigger image and/or the print. Thus it can be eligible for its own copyright protection.

Moving on, creating one or more Apps can be accomplished by using any now known or later developed technologies and/or methods which are capable of producing a working result. Additionally, the App is configured to be used in connection with a mobile electronic device. The mobile electronic device must have the capability of displaying the secondary content. For example, an LCD screen. Also, because secondary content can be audio based, for purposes of this application, a mechanism for display shall include within its scope audio speakers and/or headphone capabilities.

Additionally, the mobile electronic device has the ability to run at least one mobile App and due its need to communicate with a server, the mobile electronic device should have the ability to send and receive signals to and from a remotely located backend server.

The backend Server is a custom made web based application with the following roles. It can store some or all of the secondary content depending on whether the secondary content is preloaded versus streaming. Further, it can communicate with the App and authenticate the print. Moreover, the backend server functions to authorize the use of and then stream and/or push the secondary content to the App. Finally, the backend server can also provide a marketplace where users can purchase prints and Apps.

The mobile application (App) is a dedicated cell phone application which uses, for example the I-Phone 105 or Android Operation System, to deliver the object recognition and display the secondary content. As described in greater detail below, the App will include the ability to recognize objects and is designed in such a way that when it detects the print, it causes the mobile device to display the secondary content.

The App can also include a way of protecting against illegal coping and will also be configured with a technical way to prove authenticity. There are several means that currently exist which through the use of special software can help prevent illegal copying of digital content and any currently known or later developed means could be effectively applied to the disclosed system and method.

Furthermore, there could be an additional part of the App apart from the digital secondary content that provides relevant information about the artist, and could even allow a user to communicate with the artist's personal website or gallery website providing the user with relevant updated information. Another feature that can be added to the App is an ability to communicate with social media. Thus, it can link the user with social media outlets used by the artist, generating a direct link between the artwork and the creator trough the art piece.

Also, the disclosed system and method can also be executed in such a way that the creation of the secondary content and the creation of the at least one App is done as a collaboration between a production studio and various other parties. A production studio can be made up of a group of people with varying technical expertise. A non-exhaustive list of relevant areas of expertise may include computer graphics, augmented reality, software development, information technology and wireless communications.

If the original trigger image is a well known work of art, an example of a collaborative effort would be the production studio sitting down with the artist and providing technical knowledge that will enables the artist to generate an audiovisual piece that will accompany the trigger image piece. As a result, what we will see is a collaboration between the artist and a “production studio,” that provides the technological support for the video or the digital component whatever this might be, to be created. The members of the production studio will determine what to add to the augmented version which makes up the secondary content which in this case would be a derivative aura.

Similarly, this can be created in collaboration with another artist if the original work of art is in the public domain; If the original is copyrighted, then the derivative can be created by anyone if authorization is given by the owner of the copyright.

Moving on, as mentioned above, the App will include object recognition capabilities. The recognition of the trigger image and/or print can be accomplished by any now known or later developed technology. A non-exhaustive list and description of possible object recognition systems is as follows.

Object recognition can be accomplished by any of the many known forms of picture analyzing or image recognition technology. In this case, the print will have special visual code or sign (which could be part of the print itself). The App will take a snapshot of the print and send it back to the server and wait for the server's reply. The backend server will then analyze the picture and search for the special code or sign. If it is found, the server will stream/download the secondary content to the App. The whole process will be in real-time (i.e., a second or less).

By contrast, if the form of object recognition is not one of the many forms of image recognition then the print is to be embedded with something that emits a radiation that can be picked up by some type of receiver. For example, Radio Frequency Identification (RFID) can be used. RFID is the use of a wireless non-contact system that uses radio-frequency electromagnetic fields to transfer data from a tag attached to an object, for the purposes of automatic identification and tracking. Some tags require no battery and are powered by the electromagnetic fields used to read them. Others use a local power source and emit radio waves (electromagnetic radiation at radio frequencies).

Here, the print will be embedded with an RFID tag which has a unique code. The App will then identify the RFID tag either directly or with the aid of an external device. The App will then combine the RFID tag code with a build-in Mobile App code (2 keys encryption), create a unique access token which it will send back to the Server. The backend server will then authenticate the App user, decrypted the key and authorized to stream/download the Secondary Content.

Another form of object recognition that can be used is barcode technology. A barcode is an optical machine-readable representation of data, which shows data about the object to which it attaches. Originally barcodes represented data by varying the widths and spacings of parallel lines, and may be referred to as linear or one-dimensional (1D). However, they have now evolved to include rectangles, dots, hexagons and other geometric patterns in two dimensions (2D). In this case, the print will have an embedded barcode tag with a unique code. The App will identify the barcode tag and will combine the tag code with a build-in Mobile App code (2 keys encryption). It will then create a unique access token and will send it back to the server. Then the backend server will authenticate the App user, decrypt the key and authorized to stream/download the secondary content.

Yet another option for object recognition is Bluetooth technology. Bluetooth uses a radio technology called frequency-hopping spread spectrum. It is a standard wire-replacement communications protocol primarily designed for low power consumption, with a short range based on low-cost transceiver microchips in each device. Because the devices use a radio (broadcast) communications system, they do not have to be in visual line of sight of each other, however a quasi optical wireless path must be viable.

Here, the print must be fitted with a Bluetooth device which requires a power source. The App will sync with Print and then will pull the print code. It will then combine the code with a build-in Mobile App code (2 keys encryption), create a unique access token and will send back to the server. Then the backend server will authenticate the App user, decrypt the key and authorize it to stream/download the secondary content.

Also, infrared signature recognition technology could be utilized.

For example, when the print is a painting, because each painting has its own specific and unique paint layers in certain area it can absorb and radiate head in a characteristic way. Thus, either directly or with the aid of an external device, the App could identify the unique heat signature given off by a particular painting and convert that into a code. It would then combine the code with a build-in Mobile App code (2 keys encryption) to create a unique access token which it would then send back to the Server.

Furthermore, the disclosed system and method can be user interactive. That is parts of the secondary content can be changed or updated in response to user activity. Certain parts of the aura can reside on the server and part can reside on the App (on the device). Therefore, certain aspects of the secondary content can be changed or updated. Using their mobile device, a user can send a signal to activate the App and cause the device to display the secondary content. For example, a user could tweet the artist and request certain color changes. Then the artist or another entity which handles the secondary content (e.g., a production studio) can reply to the tweet/suggestion by uploading content on the server/app.

Alternatively, software provided on the App, can be configured to reply to all possible requests from the user via their mobile device. It thus follows that the disclosed system and method could include a studio application which is a custom made applications to allow artists to create and upload the secondary content. Similarly, the disclosed system and method can include creating and providing an E-commerce (custom made) web based application as a marketplace to provide online shopping of Art Objects and Secondary content. Additionally, the instant method and system can incorporate a secondary content warehouse. This is an online repository (i.e., a place where secondary content is deposited or stored for current or future use by those who manage content in connection with the App and secondary content.

Also, as mentioned above, the disclosed system and method calls for the coupling of the print with the App and their use and treatment as a single unit. This single unit is a hybrid formed by the two pieces together. In the hypothetical above, the hybrid is a combination of the image of the art work embodied in the print with the a unique app which will trigger display of the derivative aura.

Thus, for purposes of this application, the term treatment includes sale and the term single unit shall include single product. Accordingly, a few non-exhaustive examples of treatment as a single unit include the two pieces being literally packaged together in a store. Also, a person who buys the print, can go to the app store and get the app. Or he can buy the app and then send for the print. Further, when someone purchases the combination product, they can receive the print and then download the aura from a website. Also, for purposes of this application, treatment as a single unit can include use together and giving the two pieces as a single gift.

The disclosed system and method can push or stream the secondary content in several ways depending upon where the secondary content is stored. When the secondary content is pre-loaded on the App, the user buy the print and the App with pre-loaded secondary content from any external source. The user then will login to the App and activate the Object recognition feature. The App recognizes Embedded Code in the print and then authorizes the use of secondary content without connecting to the backend server. Then the App activates and/or displays the secondary content.

Alternatively, when streaming download secondary content, the user buys the print and downloads the App to his mobile device. The user then logs in to the App and activate the Object recognition feature. The App then recognizes the embedded code in the print, the App authenticates the user with the backend server. Then the backend server authorizes the use of secondary content by virtue of them using the specific App. The backend Server then makes secondary content available to the App and the App activates and displays its downloaded secondary content.

To upload existing secondary content, the artist activates the studio App and creates new secondary content entity on the warehouse. The artist then associates existing secondary content with the new entity. The studio App uploads secondary content to the warehouse and makes it available for general consumption.

Additionally, to create new secondary content using the studio App, the artist activates the studio App, creates new secondary content (in form of dedicated mobile App) on the studio App. They then create a new secondary content entity on the warehouse and associates the new secondary content with the new entity. The studio App then uploads the secondary content to the warehouse and makes it available for general consumption.

As briefly described in the hypothetical above, the disclosed method's use in contemporary art could be to expand the artwork, enrich it and create a new experience in connection with it. An experience created and determined by the artist that created the art piece on your wall in collaboration with a production studio.

The key element is that this hybrid system and method could provide the means and integrated components that make a contemporary art work valuable: scarcity, the direct input of the creator, the authenticity of the experience by the artist themself.

So now, it is not easy to decide who is the next Mozart or the next Van Gogh, but if you allow contemporary visual artists that have had a proven record of creating compelling works of art in other mediums like painting or printmaking, to expand their production with the help of computer programmers, motion animators, video artist trough the disclosed method, we will increase the chances of generating important works of art that will take into consideration the times and the way that we access images in the twenty-first century and that will reflect the way we use our digital devises to interact with the world.

The artists that we would like to work with must have a track record in the art world they should have shown that their work has legitimate appeal, a professional career, a market, preferably a gallery that is in charge of their work and an interest in expanding their production with this new method of the hybrid, in the same way that a painter expands her work production by collaborating with a publisher to create an art book, or a print maker to create a limited edition of prints of his images.

Despite the fact that the two pieces are linked together in the hybrid and are one of a kind or one of a limited series. This last point observes the rules of the art market and fits with the historical notions of art history that considers that only works that are overseen personally by an artist are considered authentic.

While specific embodiments have been shown and described in detail to illustrate the application of the principles, it will be understood that the various embodiments may be embodied otherwise without departing from such principles.

What is claimed is:

1. A method for enabling immediate access to secondary content comprising the following steps:
obtaining an original trigger image;
creating a print of the original trigger image;
creating digital secondary content using technology, the digital secondary content comprising at least a first portion;
creating at least one mobile application for use in connection with a mobile electronic device, the mobile electronic device comprising display means, and at least one of means for running at least one mobile application and means for sending and receiving signals to and from a remotely located backend server, the mobile application comprising means for object recognition and being designed so that when the at least one mobile application detects the original trigger image the electronic device displays the digital secondary content; and
combining the at least one mobile application with the print of the original trigger image for treatment as a single unit.

2. A method as claimed in claim 1:
the print comprising at least one of at least one embedded code and a visual sign;
the digital secondary content comprising one of picture based media, video based media, audio based media and a dedicated software application;
the at least one mobile application being located on one of the mobile electronic device and the remotely located backend server;
the means for object recognition comprising at least one of image recognition means, radio signature recognition means, barcode recognition means, bluetooth technology and infrared signature recognition means;
treatment as a single unit comprises one of selling, using and giving away; and
all the digital secondary content is located on one of the mobile application and the backend server.

3. A method as claimed in claim 2: wherein,
creating digital secondary content and creating at least one mobile application is a collaboration between a production studio and at least one of an original artist, a third party copyright holder and an authorized consultant;
the original trigger image comprising one of a work of art and an image of a work of art;
the at least one mobile application further comprising an authentication code; and
the mobile electronic device further comprising image capturing means.

4. A method as claimed in claim 3, further comprising one of updating the digital secondary content and adding additional digital secondary content.

5. A method as claimed in claim 4, further comprising:
creating and providing at least one online marketplace comprised of an E-commerce web based application to provide online shopping for prints and mobile applications;
creating and providing at least one online repository for depositing and storing information to used in connection with creating digital secondary content; and
creating and providing at least one studio application to allow artists to create and upload digital secondary content;
wherein the electronic device is comprised of one of a smartphone and a tablet computer, the image capturing means comprising an integral camera and the display means comprising an LCD screen.

6. A method as claimed in claim 5, wherein the print comprises a front side and a back side, the back side being provided with means for attaching the printout to a surface

7. A method as claimed in claim 3,
the digital secondary content comprising a second portion, the first portion begin located on the mobile application and the second portion being located on the remotely located backend server; and
the method further comprising one of updating the second portion of the digital secondary content and adding additional digital secondary content.

8. A method as claimed in claim 7,
the print comprising a front side and a back side, the back side comprising means for attaching the printout to a surface; and
the electronic device being comprised of one of a smartphone and a tablet computer, the image capturing means comprising an integral camera and the display means comprising an LCD screen.

9. A method as claimed in claim 8, further comprising:
creating and providing at least one online marketplace comprised of an E-commerce web based application to provide online shopping for prints and mobile applications;
creating and providing at least one online repository for depositing and storing information to used in connection with creating digital secondary content; and
creating and providing at least one studio application to allow artists to create and upload digital secondary content.

10. A method for enabling immediate access to secondary content comprising the following steps:
selecting an original trigger image by capturing the original trigger image with an electronic device comprising image capturing means;
converting the original trigger image into an electronic file;
creating a print of the original trigger image;
transforming the electronic file of the original trigger image using technology to create digital secondary content, the digital secondary content comprising at least a first portion;
transforming at least the first portion of the digital secondary content into at least one mobile application for use in connection with a mobile electronic device, the mobile electronic device comprising display means, and at least one of means for running at least one mobile application and means for sending and receiving signals to and from a remotely located backend server, the mobile application comprising means for object recognition and being designed so that when the at least one mobile application detects the original trigger image the electronic device displays the digital secondary content; and
combining the at least one mobile application with the print of the original trigger image for treatment as a single unit.

11. A method as claimed in claim 10:
the print comprises at least one of embedded code and a visual sign;
the digital secondary content comprising one of picture based media, video based media, audio based media and a dedicated software application;
the at least one mobile application being located on one of the mobile electronic device and the remotely located backend server;
the means for object recognition comprising at least one of image recognition means, radio signature recognition means, barcode recognition means, bluetooth technology and infrared signature recognition means;
treatment as a single unit comprises one of selling, using and giving away; and
all the digital secondary content is located on one of the mobile application and the backend server.

12. A method as claimed in claim 11:
the original trigger image comprising one of a work of art and an image of a work of art;
creating digital secondary content and transforming the electronic file of the original trigger image using technology to create digital secondary content is a collaboration between a production studio and at least one of an original artist, a third party copyright holder and an authorized consultant;
the at least one mobile application further comprises an authentication code; and
the mobile electronic device further comprises image capturing means.

13. A method as claimed in claim 12, further comprising one of updating the digital secondary content and adding additional digital secondary content.

14. A method as claimed in claim 13, further comprising:
creating and providing at least one online marketplace comprised of an E-commerce web based application to provide online shopping for prints and mobile applications;
creating and providing at least one online repository for depositing and storing information to used in connection with creating digital secondary content; and
creating and providing at least one studio application to allow artists to create and upload digital secondary content;
wherein the electronic device is comprised of one of a smartphone and a tablet computer, the image capturing means comprising an integral camera and the display means comprising an LCD screen.

15. A method as claimed in claim 14, the print comprising a front side and a back side, the back side comprising with means for attaching the printout to a surface.

16. A method as claimed in claim 12,
the digital secondary content comprising a second portion, the first portion begin located on the mobile application and the second portion being located on the remotely located backend server; and
the method further comprising one of updating the second portion of the digital secondary content and adding additional digital secondary content.

17. A method as claimed in claim 16,
the print comprising a front side and a back side, the back side comprising means for attaching the printout to a surface; and
the electronic device being comprised of one of a smartphone and a tablet computer, the image capturing means comprising an integral camera and the display means comprising an LCD screen.

18. A method as claimed in claim 17, further comprising:
creating and providing at least one online marketplace comprised of an E-commerce web based application to provide online shopping for prints and mobile applications;
creating and providing at least one online repository for depositing and storing information to be used in connection with creating digital secondary content; and
creating and providing at least one studio application to allow artists to create and upload digital secondary content.
